(19) United States
(12) Patent Application Publication
(10) Pub. No.: US 2004/0227767 A1
(43) Pub. Date: Nov. 18, 2004

(54) Vector graphics circuit accelerator for display systems

(76) Inventors: Alberto Baroncelli, Florence (IT); Francesco Buzzigoli, Florence (IT)

Correspondence Address: DELLETT AND WALTERS, P. O. BOX 2786, PORTLAND, OR, 97208-2786, US

(21) Appl. No.: 10/601,274

(22) Filed: Jun. 19, 2003

Related U.S. Application Data
(60) Provisional application No. 60/390,714, filed on Jun. 20, 2002.

(51) Int. Cl. G09G 5/36; G09G 5/02

(52) U.S. Cl. 345/589; 345/553; 345/549

(57) ABSTRACT

A high performance accelerator circuit for streamed and not-streamed vector graphics applications and multimedia contents, which provides increased performance for vector graphics applications and multimedia contents over current computer and handheld architectures. The Vector Graphics Unit circuit includes means for fast drawing of quadratic and cubic Bézier curves (i.e. fonts, curved object etc . . . ), hardware compositing of solid and transparent objects and fast antialiasing hardware unit. The Vector Graphics Unit is particularly suitable for commercial appliances having high quality graphics and low power consumption features.

### BACKGROUND OF THE INVENTION

Today the popularity of client-server applications using a wire or wireless Internet connection—via portable devices— are demanding rich client vector graphics contents and rich user interfaces, based on open graphics format such as SVG, Scalable Vector Graphics, by World Wide Web Consortium and SWF by Macromedia.TM.

The displays used in such appliances are increasing in size, screen resolution and in color depth, incrementing the total number of pixels and data that have to be controlled. Such pixels rendering represents most of the times the translation of vector graphics objects, stacked in different layers with different graphics proprieties, into one or more bitmap images.

Higher screen resolution and color depth are also increasing the resources used and the power consumption of a general-purpose processor, CPU, on the mobile appliance. Therefore, mobile/smart device manufacturing firms are forced to reduce the multimedia player features and provide a very limited multimedia player performance. Comparing this solution to the full options and high-speed multimedia players on a standard personal computer architecture, desktop and notebook, this is translated most of the time to a pure look and feel by the end user.

The power consumption of said displays based on new technology, such as OLED—that do not require a backlight—, is also rapidly decreasing. Today a color QVGA OLED screen uses about the same or less power of a mobile application processor.

It is desired to have an improved system for implementing vector graphics applications and multimedia contents providing low-cost, efficient and low-power solution for running vector graphics applications and multimedia contents for consumer appliances.

### SUMMARY OF THE INVENTION

The present invention relates to a hardware Vector Graphics Unit which can be used to quickly render vector graphics objects into color, gray scale or b/w bitmaps images directly into a display, such as an OLED, color TFT, black and white LCD, CRT monitor.

Software vector graphics rendering engine usually computes the translation of vector graphics objects into bitmaps objects, by executing software on Control Process Unit (CPU) pipelines architectures.

The Vector Graphics Unit speeds up the rendering of the vector graphics objects significantly, because it removes the bottleneck, which previously occurred when the Vector Rendering Engine is executed via software on a CPU.

In the present invention all, or at least part, of the Vector Rendering Engine is implemented in hardware as the Vector Graphics Unit. The Vector Graphics Unit and the CPU can be put together on a single semiconductor chip to provide an embedded system, such as a System-on-Chip (SoC), appropriate to use with commercial appliances.

The advance of new silicon technology to <130 nm process, allows IC manufacturing firms to include highly specialized hardware IP cores, such as the VGU, with a small footprint (<1 sq. mm) into a dedicated System-on-Chip. This VGU IP core adds an amazing performance acceleration factor, while reducing CPU's resources under a well-accepted value to less than 30%. This allows smart phone and any other mobile devices that use very low power and low frequency micro controllers, to reach multimedia high-end notebook performance. Therefore, other higher priority tasks, such as voice communication, are not compromised. Such an embedded system solution is less expensive then a powerful CPU with a separated graphics acceleration chip with the advantage of very low power consumption.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram illustrating the graphics system;

FIG. 2 is a block diagram explaining the software preprocessing tasks of a CPU and the hardware processing work of the vector graphics unit;

FIG. 3 is a block diagram describing the inner parts of the vector graphics unit;

FIGS. 4(a) and 4(c) are drawings of the Bézier subdivision into 8 subcurves; 4(b) depicts a flowchart of the Bézier subdivision computation and its storage in a dual port RAM; 4(d) represents the memory content in a sequential time frames (init, 1st loop, 2nd loop, 3rd loop);

FIGS. 5(a), 5(b) and 5(d) are block diagrams of the edge and sorting processing system; 5(c) depicts a flowchart of the x-sort algorithm;

FIGS. 6(a), 6(b), 6(c) and 6(d) are illustrations of the antialiasing processes;

FIGS. 7(a) and 7(b) are illustrations of the color generation procedure with a transformed bitmap; 7(c) and 7(d) show the Radial Gradient Table and the Color Ramp Lookup Table;

FIG. 8(a) is a block diagram illustrating the inner parts of the color composer 22 and the dump-store buffers 23; FIG. 8(b) shows the update rect subdivision procedure.

### DETAILED DESCRIPTION

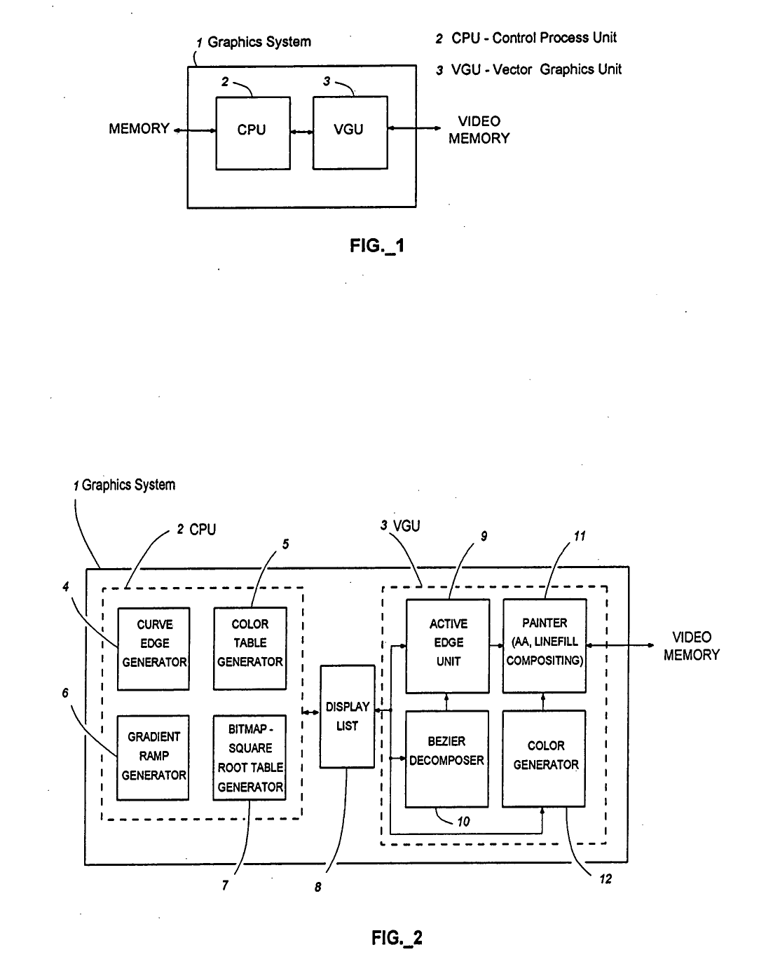

FIG. 1 is a diagram of the System 1 showing the use of a hardware Vector Graphics Unit 3 in conjunction with a Central Processing Unit 2. The Vector Graphics Unit 3 allows part of the Vector Rendering Engine to be implemented in hardware. This hardware implementation speeds up the rendering of the vector graphics objects. Particularly, in a preferred embodiment, the translation of the vector graphics objects, organized in a stacked layering schema, into a sequential scan line bitmaps is partially or completely done in the hardware Vector Graphics Unit 3. This translation has been part of a bottleneck in the Vector Rendering Engine implemented in software.

FIG. 2 illustrates details of the software preprocessing generators of CPU 2 and the Vector Graphics Unit 3. The display list 8 acts as the communication channel between the preprocessing software generators and the hardware Vector Graphics Unit 3.

The software curve edge generator 4 decomposes all the graphics objects in Bézier curves that need to be drawn in the current time frame and stores them inside the display list as an edge sequence.

The color table generator 5 adds into the display list the color used by the edge list.

The gradient ramp generator 6 creates all the gradient ramp tables used when the color is a gradient.

The bitmap and square root generator 7 converts the bitmaps, used as texture for the object to be drawn, in a suitable graphics format stored inside the display list. The square root table is a special bitmap where pixel value is the square root of its address and it is used for the objects drawn with radial gradient color.

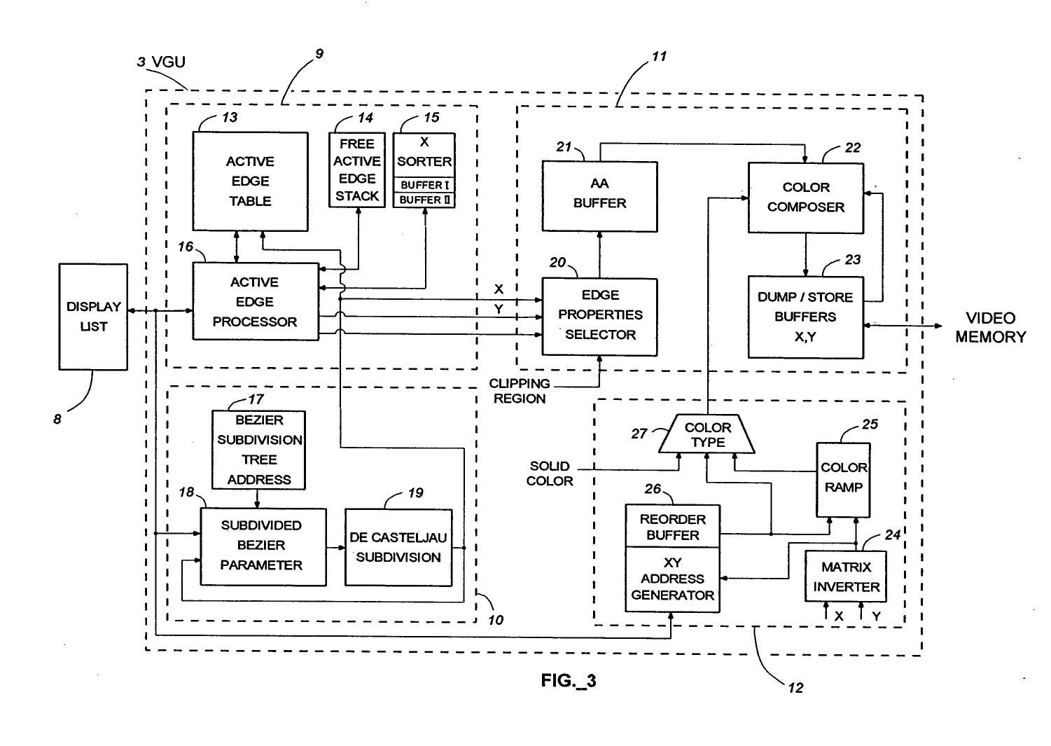

FIG. 3 shows the active edge processor 16. The active edge processor 16 loads from the display list 8 the edges that will be processed at the current scan line and it stores them into the active edge table 13 at the address generated by the free active edge stack 14. Simultaneously the Bézier decomposer 10 processes the edge data. The subdivided Bézier parameter 18 with the two other units, the De Casteljau subdivision 19 and the Bézier subdivision tree address 17, divides the Bézier into a series of segments and stores them into the active edge table 13.

The drawing 4(a) shows a quadratic Bézier curve and the illustration 4(c) its subdivision in eight segments. The subdivision is carried until eight segments are generated, but the same process can be repeated for more steps and stopped with a flatness test when the subdivided curve can be approximated to a linear segment.

Every curve with a minimum or maximum is divided by two monotonic curves therefore, with every Y step, the X coordinates always decrements or increments. In such way, all curves can be evaluated with the raster scan algorithm simply increasing the Y coordinate. In cubic Bézier curves the process is similar but with one more subdivision.

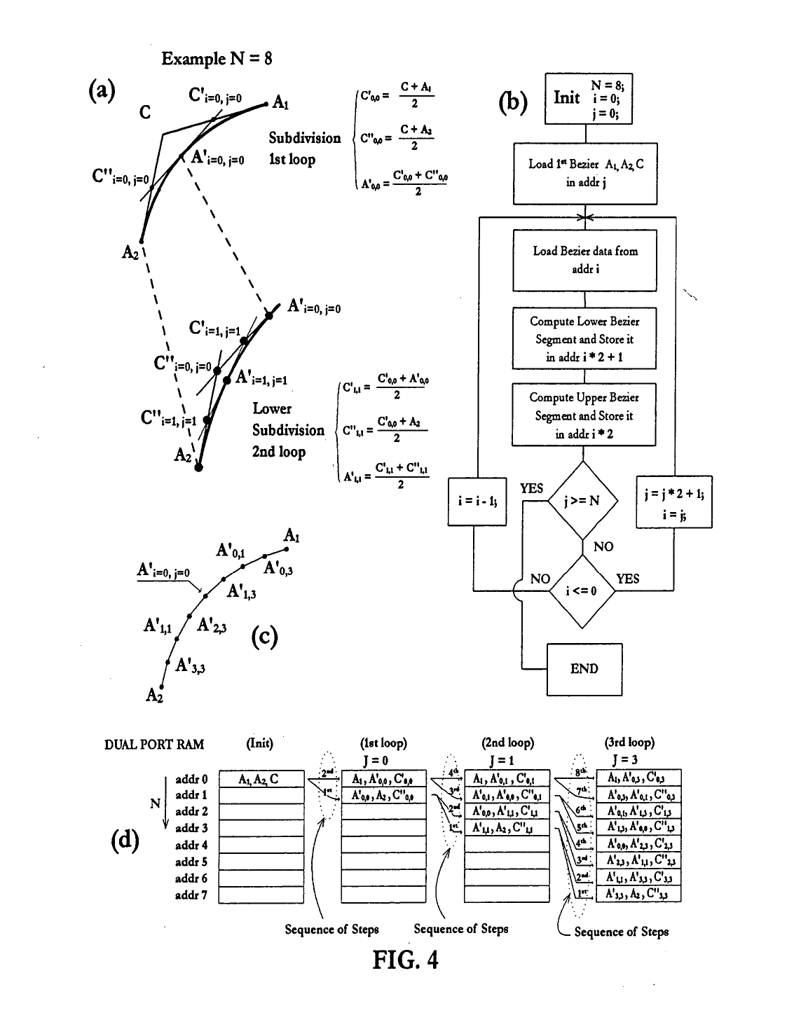

The Bézier subdivision tree address 17 is the address generator for the dual port memory, showed in FIG. 4(d), containing N segments and its structure is chosen to optimize the number of reads and writes. The memory has two ports for reading and writing in the same time to a different address. The subdivision block is composed by three couples of X and Y adders/divide by two, plus a delay element.

The sequence illustrated by the flow chart 4(b), can be described as:

0. Write the first element (three sets of X,Y coordinates representing two anchor points and one control point), that is the Bézier curve to be processed, in the first memory address location, addr 0.

1. Subdivide the points as shown in the formula and write the lower subcurve in the memory addr location 1, and the upper subcurve in the memory addr location 0. This is presented as the best sequence due to the fact that every result is calculated from the first read and the subsequent writes are determinated only by this particular and its intermediate results.

2. The subcurve of addr 1 is divided again and stored, as described before, the lower part in memory addr location 3 and upper part in the addr location 2. Same scheme for subcurve 0, divided and stored in 1 and 0 memory addr locations.

3. The process is repeated again for each subdivision and in the example the last writes is showed in FIG. 4(d), 3rd loop.

The logic block described above is extremely compact and capable of minimizing memory accesses. The subdivision process for eight segments gets executed in only 3+6+12=21 clocks.

The active edge processor 16 computes the sub-segments using the current update region and stores the slope parameters inside the active edge table 13. The active edge processor 16 stores also the points of the sub-segments into the X sorter 15 with the relative address of the active edge. During the process of scan rasterization, a Bézier curve edges, stored into the display list in ordered mode with Y increasing, are read, converted in segments and stored in the active edge table with other information such as color type, edge filling rules.

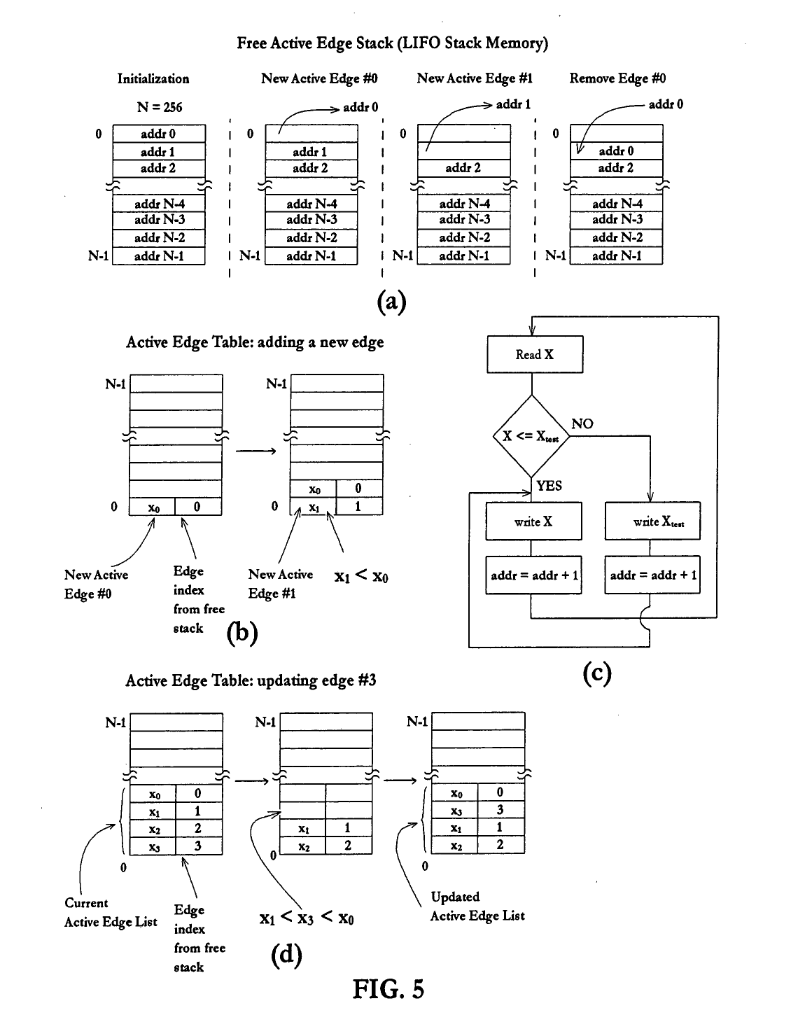

The active edge table is a small memory, where each entry is allocated dynamically with the free edge stack. This is LIFO (last input first output) stack type initialized with all the free addresses of the active edge table 13 (in the example there are 256 edge locations, N=256), as showed in FIG. 5(a). The edge #0 to be processed, coming from block 10, is stored in the active edge table 13 at the address 0 contained at the top of the free stack, FIG. 5(b). After being used, that address is removed from the stack. Next active edge, edge #1 in FIG. 5(a), will get address 1 from the top the stack, removing consequentially the data address just used. At some Y coordinate the edge #0 will be no more active (i.e. the lower anchor point is less than actual Y coordinate) and will be removed by storing again its address as first data on the top of the stack. This address will be used for the next active edge. In this way block 16 is capable of allocating all the 256 entries of the edge table without complex memory allocation strategies. FIG. 5(d) shows the reordering process when the existing active edge #3 is updated.

The limitation to N entries in the active edge means that no more than N edges, using the same color, can be active for the row. However, a more complex drawing can be decomposed to be processed in a N limited memory.

In order to execute a correct rendering, all active edges must be stored and processed with an increasing X value. The coordinate X can change according to the slope of the edges, therefore each time is necessary to sort again all the elements of the active edge table. This function is carried by the sorter block 15, composed mainly by a dual port memory where two alternating ping-pong buffers, I, II, are stored. Buffer I, FIG. 3, always reads the actual row X coordinate of the edges and their addresses in the active edge table. In this way it is possible to read all the data necessary for updating the edge X value, changing the subsegment step and rendering the object with correct color and rules. When the X coordinate is updated it is stored in buffer II. At this point the X values of each edge, processed previously, can be compared. The processed edge is inserted in the correct location X coordinate ordered, and all the upper elements are shifted one position toward the top. The sorting is executed also when an edge is not active anymore. At this time it is not necessary to compare it to the stored edge value. The step is skipped to the processing of the next active edge. In this application the sorting algorithm, as shown by the flowchart in FIG. 5(c), is simple to implement, compact and fast due to the fact that the edge distribution is not changing wildly from row to row. Instead, often they rest in the same order and only few change positions. The process of moving to the upper part of the buffer it is necessary only when the order is changed.

The edge properties selector 20 generates the paint commands of the scan line. These commands depend on the clipping value and on the type of edge (winding, even-odd, masked filling etc . . . ).

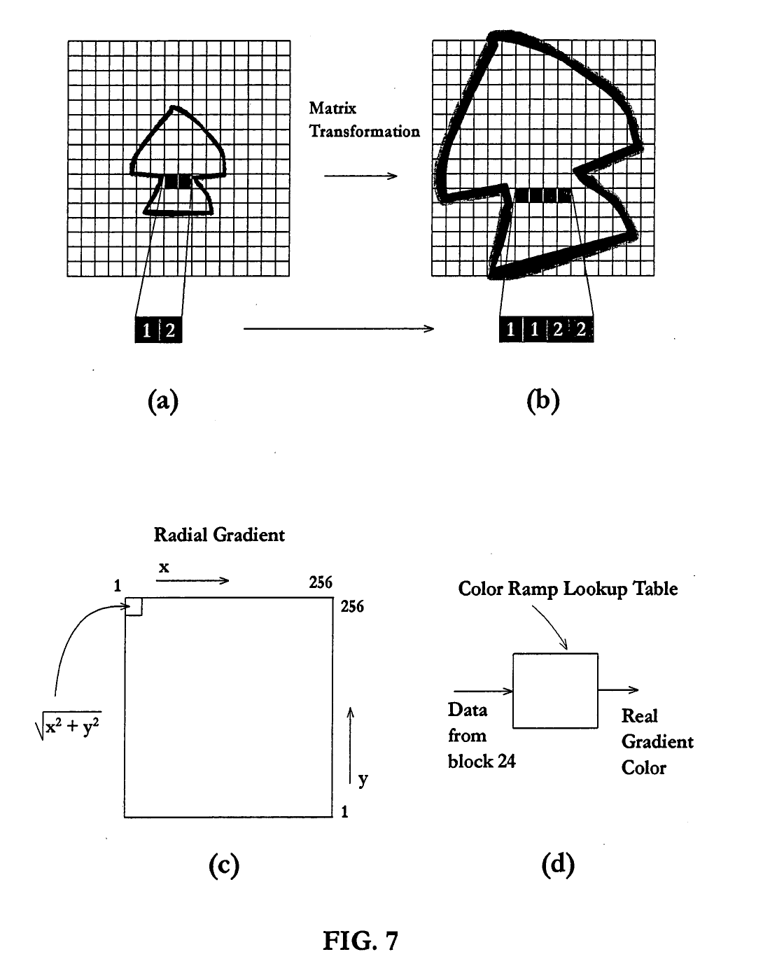

The color generator 12 outputs the solid or the processed color, when a linear gradient, a radial gradient, a tiled bitmap or a clipped bitmap are associated with the active edge. The color generator 12 uses dedicated logic to optimize in speed and in number the access to the display list memory 8, where the requested bitmaps are stored. The FIG. 7(a) and 7(b) show a typical operation for the bitmap rendering. Beginning with the source image, illustrated in FIG. 7(a), a linear transformation matrix is applied to the destination coordinate to obtain the source coordinate, and a mapping to a destination bitmap, such as FIG. 7(b). The matrix transform coefficients can be used to scale, rotate and move the source image.

The goal of circuit 22 is the optimization of the number of reads and writes to memory with a fast sequential access mode.

Generally the source image is stored inside the display list. The matrix is applied to the destination coordinates to obtain a starting source bitmap coordinate, and these are incremented with two of the matrix coefficients every time a pixel is rendered in the horizontal direction (X increasing). Each time a new address is calculated, it is checked to assure that is pointing to the same source pixel or at least the X consecutive one. The process stops when this is not anymore true. The result is a sequence of addresses stored inside a temporary memory with a number indicating how many times the source pixel must be drawn (replicated) in the destination bitmap. This sequence is used to read the source bitmap and to write in the destination bitmap. In the example of FIG. 7(a), pixel 1 and 2 are the only part of the same column, this means a read sequence of 2 pixels and a write sequence of 4 pixels as two consecutive replicated couples.

When the color type is a radial gradient, a special bitmap inside the display list is used. It is called square root lookup table with a width and height of 256×256 pixels, as illustrated in FIG. 7(c). The pixel value in each location is simply the square root of the sum of the squared X and Y, practically the polar distance from bitmap coordinate origin. Matrix inverter 24 works in the same way as for bitmaps, transforming the destination coordinates to the source coordinate and reading the memory. This time the matrix inverter 24 passes the value to the color ramp 25 to address another color ramp lookup table, FIG. 7(d). The result is the real gradient color to be applied at each rendered pixel in the color composer 22. Access sequence optimization is executed as described for bitmaps.

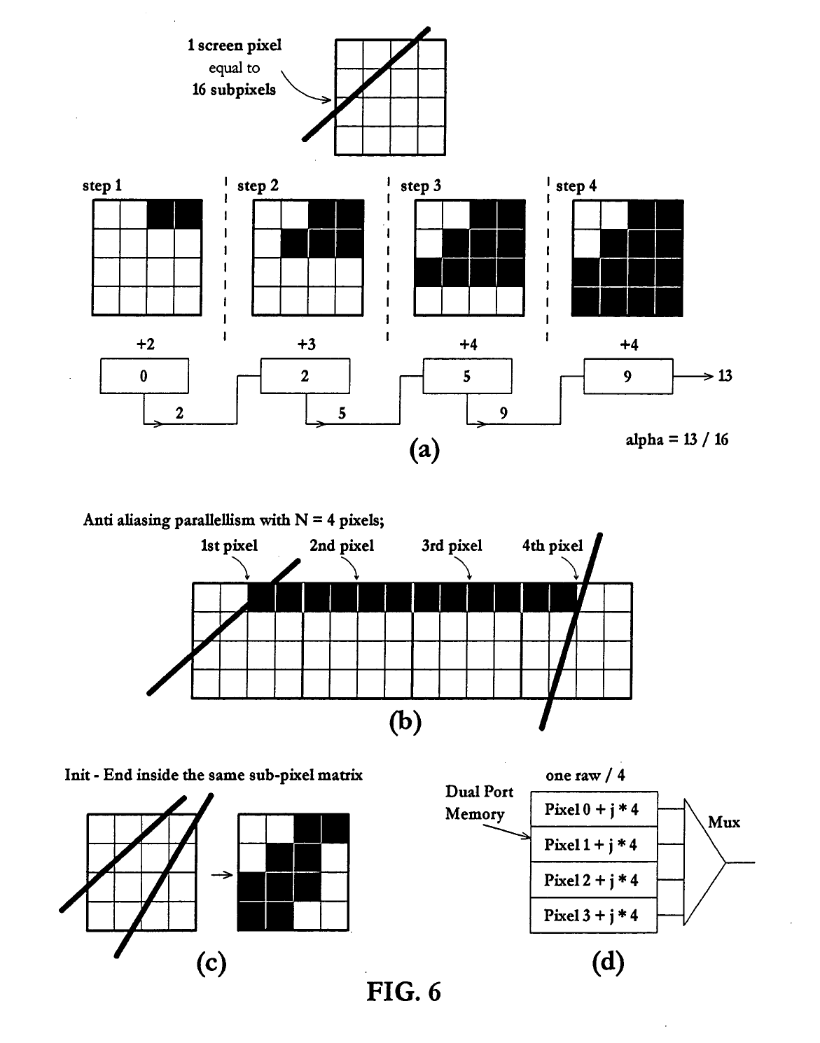

The antialiasing buffer 21 computes the number of sub-pixels present in a real pixel, obtaining a weight factor for scan-converted row. The antialiasing process works with a coordinate resolution four times greater then the real pixel size. FIG. 6(a) shows how sixteen subpixels, part of each display pixel, are drawn inside the memory. In this case a segment with positive slope is processed in four consecutive steps:

0. In the first subrow two subpixels are set, consequently a 2 is loaded in the corresponding memory location (in pixel);

1. In the second subrow an additional three subpixels are set, consequently a 3 is added to the previous memory content and result 5 is stored again;

2. In the third subrow 4 is summed and a 9 is stored;

3. In the last subrow again 4 is summed and the final result will be 13, therefore the antialiasing weight factor for that pixel will be 13/16.

The invention peculiarity is based on the AA buffer 21, which is a parallel adder group, capable of processing 4 real pixels (16 subpixels) at the same time, as showed in FIG. 6(b). The antialiasing block in this example, comprising a dual port memory, can process 4 pixels in each clock. It is straightforward and fast to increase parallelism to 8 or 16 real pixel each clock, simply increasing the adder logic and the memory width.

FIG. 6(c) shows that the antialiasing logic can also calculate weights when the starting and ending edge are part of the same pixel.

The output of the antialiasing buffer is used as input for the color composer 22, with a multiplexer selecting each time the correct pixel weight, as illustrated in FIG. 6(d).

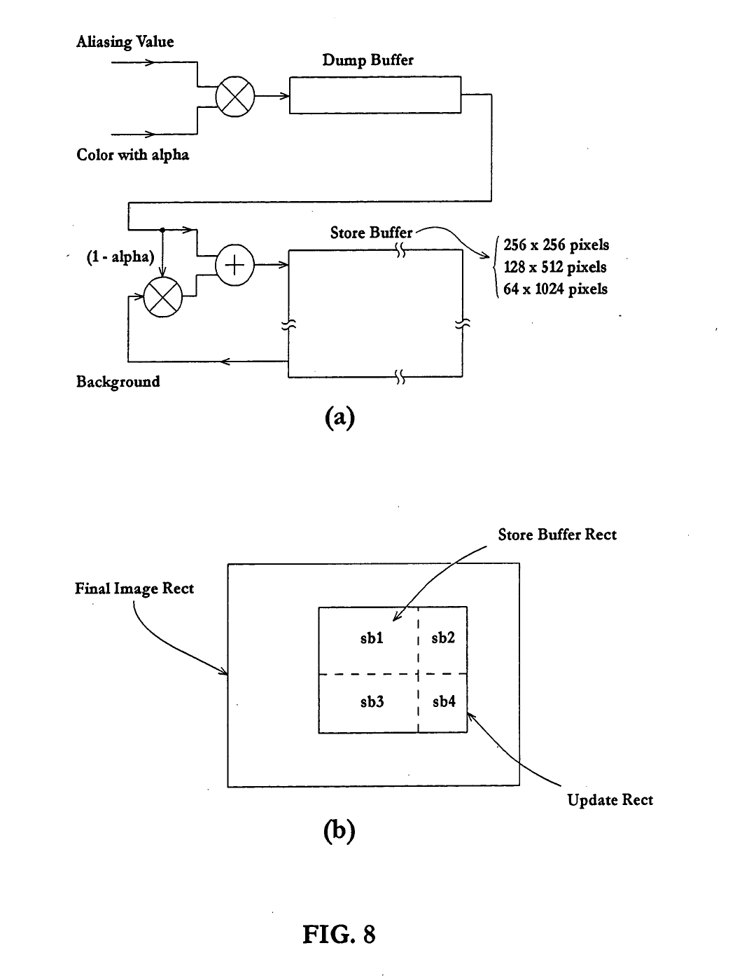

The color composer 22 uses the weight factor to process the color from the color generator 12 and stores the result into the dump buffer 23. The FIG. 8(a) shows the color composing with transparence and with antialiasing percentage generated by AA buffer 21. The final result is stored inside the dump buffer of block 23.

In a second phase the data from the dump buffer is read and composed once again with the background in this sequence:

1. Read the background pixel from the store buffer memory of the block 23, multiply it by the complementary of the transparence (1−alpha), obtained from the dump buffer, and add it with the red, green, blue values again from the dump buffer.

2. The result is written inside the store buffer of the block 23, a memory less or at maximum equal to the display memory, that can be re-adjusted in size each scan conversion. The size can be power of two, such as 256×256 pixels, 128×512 pixels or 64×10²⁴ pixels. Its dimensions are function of the memory technology used in the system (SDRAM, SRAM etc.), and the technique that can be used to access the memories every time in the most efficient way (i.e. burst read/writes for SDRAM).

The FIG. 8(b) shows the update boundary of the drawing process, the update rect. This rectangle is related only to the area where some changes are caused by the animation. In this example the update-rect is greater than the store buffer memory. Therefore the software curve edge generator 4 will divide the update rect in blocks compatible with the possible size configurations of the store buffer memory of block 23. Optimization is done to obtain a minimum value of possible sub-blocks that cover all the update area.

In the example of FIG. 8(b), 4 portions are generated, each one capable to be stored inside the store buffer of block 23.

All the complete raster process, described in the display list, is executed in the store buffer with an update rect limits set to the coordinate vertexes of the sub-update area sb1.

The last step is to copy the buffer content in the display memory. The same raster sequence is repeated again for each sub-update area sb2, sb3 and sb4.

In this way is possible to reduce the number of the external display memory accesses, decreasing external memory bandwidth. Also the internal data path of the store buffer can be easily made greater than i.e. 1024 bits compared to the standard 32/64 bits used in external bus configurations. The power consumed by the system is also decreased, because current, voltages and capacities inside the integrated circuit are always less than the external ones used for connection between separate ICs.

The circuit has unique arrangement for update boundary rect that can be decomposed in separated buffers with programmable height and width, optimizing the number of display list rendering steps, and lowering the external memory bandwidth.

The Vector Graphics Unit 3 of the present invention is particularly well suited to an embedded solution, such as a System-on-Chip, in which the hardware accelerator is positioned on the same chip as the existing CPU design. In addition, the architecture of the present embodiment is scalable to fit a variety of applications, ranging from smart phone integrated architecture to professional solutions, where the processor and the VGU unit are discrete IC components.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A vector graphics circuit for rendering vector and bitmap graphics objects to a final image, the vector graphics circuit comprising:
a. an input display list means for receiving an input stream of data;
b. a sorting hardware circuit for optimizing the scan conversion algorithm;
c. a Bézier hardware circuit for vector curve subdivision;
d. an antialiasing hardware circuit for calculating sub-pixel values;
e. a color hardware circuit for reordering and for optimizing the access to a plurality of bitmaps and mathematical tables inside the display list memory;
f. a dump buffer hardware circuit, using a memory, which composes the vector graphics objects in a final pixel bitmap.

2. A vector graphics circuit according to claim 1 wherein the input display list means is arranged to include a quadratic or cubic Bézier edge data list.

3. A vector graphics circuit according to claim 2 wherein the input display list means is arranged to include a color data list.

4. A vector graphics circuit according to claim 3 wherein the input display list means is arranged to include a color rump data list.

5. A vector graphics circuit according to claim 3 wherein the input display list means is arranged to include a pattern or bitmap data list.

6. A vector graphics circuit according to claim 1 wherein the sorting hardware circuit comprises:
a. an active edge processor subunit that stores the edges of a current scan line inside an active edge table with increasing X, the active edge table comprises a dual port memory, where two alternating ping-pong buffers are stored;
b. a free active edge stack acting as a LIFO stack, to generate the address of the active edge table.

7. A vector graphics circuit according to claim 1 wherein a Bézier hardware circuit store a series of segments inside an dual port memory comprising:
a. a subdivided Bézier parameter unit, comprising three couples of X and Y adders/divide by two, plus a delay element;
b. a De Casteljau subdivision unit;
c. a Bézier subdivision tree address unit that generates the address locations of the Bézier segments inside a dual port memory.

8. A vector graphics circuit according to claim 1 wherein the antialiasing hardware circuit computes the number of sub-pixels present in a N=i*4 real pixels per clock, to obtained the weight factor used for a scan-converted row.

9. A vector graphics circuit according to claim 1 wherein the color hardware circuit includes:
a. a color generator sub unit that outputs a solid or a processed color when a linear gradient, a radial gradient a tiled bitmap or a clipped bitmap are associated with the active edge;
b. a color composer sub unit that uses the weight factor to process the color from the color generator and store the result in to a dump buffer.

10. A vector graphics circuit according to claim 1 wherein the buffer hardware circuit stores a pixel region into a buffer, where all the objects are composed, comprising:
a. a fixed single line dump buffer memory that stores the color pixels processed by an antialiasing and transparence factors;
b. a store buffer memory that stores the color pixel value using the following algorithm:
i. Read the background pixel from the store buffer memory, multiply it by the complementary of the transparence (1−alpha), obtained from the dump buffer, and add it with the red, green, blue values again from the dump buffer.
ii. The result is written again inside the store buffer.

12. A vector graphics circuit according to claim 1 wherein a Bézier hardware circuit store a series of segments inside an dual port memory comprising:
a subdivided Bézier parameter unit, comprising three couples of X and Y adders/divide by two, plus a delay element.

13. A vector graphics circuit according to claim 1 wherein a Bézier hardware circuit store a series of segments inside an dual port memory comprising:
a De Casteljau subdivision unit.

14. A vector graphics circuit according to claim 1 wherein a Bézier hardware circuit store a series of segments inside an dual port memory comprising:
a Bézier subdivision tree address unit that generates the address locations of the Bézier segments inside a dual port memory;

15. A vector graphics circuit for rendering vector and bitmap graphics objects to a final image, the vector graphics circuit comprising:
a. an input display list means for receiving an input stream of data;
b. a sorting hardware circuit for optimizing the scan conversion algorithm;
c. a Bézier hardware circuit for vector curve subdivision;
d. an antialiasing hardware circuit for calculating sub-pixel values;
e. a color hardware circuit for reordering and for optimizing the access to a plurality of bitmaps and mathematical tables inside the display list memory;
f. a dump buffer hardware circuit, using a memory, which composes the vector graphics objects in a final pixel bitmap,
wherein the input display list means is arranged to include a quadratic or cubic Bézier edge data list,
wherein the input display list means is arranged to include a color data list,
wherein the input display list means is arranged to include a color rump data list,
wherein the input display list means is arranged to include a pattern or bitmap data list,
wherein the sorting hardware circuit comprises:
a. an active edge processor subunit that stores the edges of a current scan line inside an active edge table with increasing X,
the active edge table comprising a dual port memory, where two alternating ping-pong buffers are stored;
b. a free active edge stack acting as a LIFO stack, to generate the address of the active edge table,
wherein a Bézier hardware circuit store a series of segments inside an dual port memory comprising:
a. a subdivided Bézier parameter unit, comprising three couples of X and Y adders/divide by two, plus a delay element;
b. a De Casteljau subdivision unit;
c. a Bézier subdivision tree address unit that generates the address locations of the Bézier segments inside a dual port memory,
wherein the antialiasing hardware circuit computes the number of sub-pixels present in a N=i*4 real pixels per clock, to obtained the weight factor used for a scan-converted row,
wherein the color hardware circuit includes:
a. a color generator sub unit that outputs a solid or a processed color when a linear gradient, a radial gradient a tiled bitmap or a clipped bitmap are associated with the active edge;
b. a color composer sub unit that uses the weight factor to process the color from the color generator and store the result in to a dump buffer,
wherein the buffer hardware circuit stores a pixel region into a buffer, where all the objects are composed, comprising:
a. a fixed single line dump buffer memory that stores the color pixels processed by an antialiasing and transparence factors;
b. a store buffer memory that stores the color pixel value using the following algorithm:
i. Read the background pixel from the store buffer memory, multiply it by the complementary of the transparence (1−alpha), obtained from the dump buffer, and add it with the red, green, blue values again from the dump buffer.
ii. The result is written again inside the store buffer.
